(19) United States
(12) Patent Application Publication
(10) Pub. No.: US 2012/0191885 A1
(43) Pub. Date: Jul. 26, 2012

(54) METHOD FOR CONFIGURING CHARGING PORTS AND CONTROLLER APPLYING THE SAME

(75) Inventors: Li-Feng Kuo, Taipei County (TW); Pao-Shun Tseng, Taipei County (TW); Chin-Yu Chang, Taipei County (TW)

(73) Assignee: ASMedia Technology Inc., New Taipei City (TW)

(21) Appl. No.: 13/353,391

(22) Filed: Jan. 19, 2012

(30) Foreign Application Priority Data
Jan. 24, 2011 (TW) 100102542

(51) Int. Cl. G06F 13/36

(52) U.S. Cl. 710/104; 710/113

(57) ABSTRACT

A method for configuring charging ports and a controller applying the same are disclosed. The method includes recording a maximum permission value and a permitted value, and comparing the maximum permission value and the permitted value to determine whether the interface port can be used as a charging port when a device is connected to an interface port.

This application claims the benefit of Taiwan application Serial No. 100102542, filed Jan. 24, 2011, the subject matter of which is incorporated herein by reference.

### BACKGROUND OF THE INVENTION

1. Field of the Invention

The invention relates to a method for configuring charging ports and a controller applying the same and, more particularly, to a method and a controller applying the same for dynamically configuring multiple charging ports according to charging requirements at interface ports connected to devices.

2. Description of the Related Art

An electronic system, such as a computer system, usually includes interface ports for connecting (or coupling) to various kinds of external devices. For example, a computer system may include multiple interface ports of universal serial bus (USB) specification for exchanging data and signals with external devices.

In common specification of interface ports, data in the electronic system can be exchanged with the external devices via the interface port, and the devices can also be charged via the interface port. For example, if each of the devices is powered by a battery, the battery can be charged via the interface port when the device is connected to the interface port, such as a battery charging specification is included in the USB specification. Since sufficient current is needed in a charging process, the interface port which can provide a sufficient current (larger than a preset current) can be estimated as a charging port for the device.

However, multiple interface ports are included in the electronic system, the total power which can be provided to the each of the interface ports is limited, therefore, not each of the interface ports can be used as the charging port.

In a charging port configuration, one or several constant interface port of the electronic system can be used as the charging port, while others cannot be used as the charging port. Thus, users have to connect the device to the constant interface port for charging. However, if the user connects the device to other interface port which is not the charging port, the device cannot be charged, which causes inconvenience.

### BRIEF SUMMARY OF THE INVENTION

A method which can flexibly configure charging ports is provided, it can dynamically configure the charging ports according to the charging requirements at the interface ports connected to the device.

A method for configuring charging ports includes steps of: recording a maximum permission value and recording a permitted value. When a device is connected to an interface port, the maximum permission value and the permitted value are compared to determine whether the interface port can be used as the charging port. If the maximum permission value is larger than the permitted value, a status bit of the interface port is set at a first content (such as logic 1) to permit the interface port to be used as the charging port. The permitted value is changed accordingly, for example, the permitted value increases by “one” to represent that one more interface port can be used as the charging port.

On the contrary, if the maximum permission value equals to the permitted value, the status bit of the interface port is set at a second content (such as logic 0), and the interface port is not used as the charging port.

When a device is detached from an interface port, whether the status bit of the interface port is the first content is detected. If yes, the status bit is reset to the second content, and the permitted value is restored. For example, the permitted value is decreased by “one” to represent that an interface port is not used as the charging port.

A controller for controlling multiple interface ports is also disclosed herein. The controller includes a first register, a second register, a status register and an arbitration module. The first register records a maximum permission value, and the second register records a permitted value. When a device is connected to one interface port, the arbitration module compares the maximum permission value and the permitted value to determine whether the interface port can be used as a charging port. If the maximum permission value is larger than the permitted value, the arbitration module sets a status bit of the interface port at a first content to permit the interface port to be used as the charging port and changes the permitted value accordingly. On the contrary, the arbitration module sets the status bit of the interface port at the second content and forbids the interface port to be used as the charging port.

When a device is detached from one interface port, the arbitration module detects whether the status bit of the interface port is the first content. If yes, the arbitration module sets the status bit of the interface port at the second content and rerecords the permitted value.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a charging port configuration of a conventional controller;

FIG. 2 is a schematic diagram showing a charging port configuration of a controller in an embodiment; and

FIG. 3 and FIG. 4 are flow charts showing operation steps of the controller in FIG. 2.

### DETAILED DESCRIPTION OF THE EMBODIMENTS

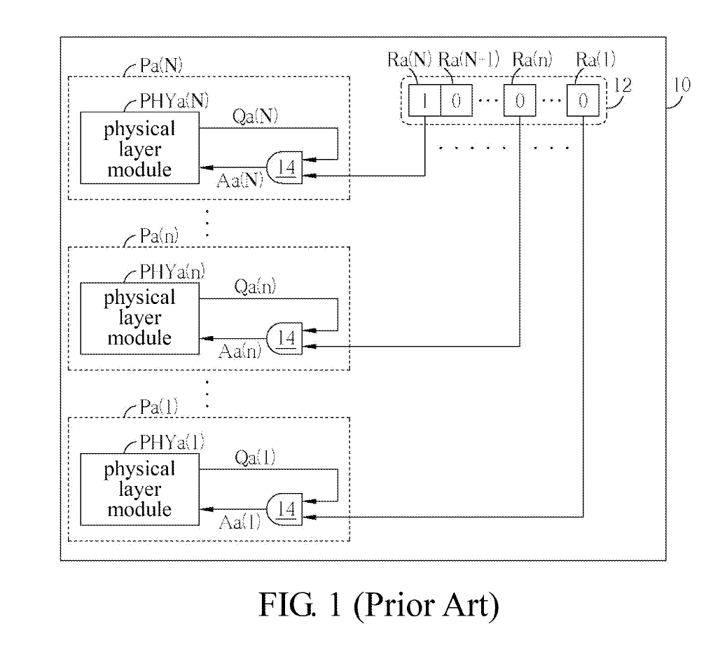

FIG. 1 is a schematic diagram showing a charging port configuration of a conventional controller 10. The controller 10 controls interface ports Pa(1) to Pa(N) and includes a status register 12. The status register 12 includes bits Ra(1) to Ra(N) as status bits corresponding to the interface ports Pa(1) to Pa(N). The bit Ra(n) corresponds to the interface port Pa(n) and its content indicates whether the interface port Pa(n) can be used as a charging port.

Since circuit architecture of the interface ports Pa(1) to Pa(N) are the same, the interface port Pa(n) is taken as an example. The interface port Pa(n) can be connected to a device (not shown) and includes a physical layer module PHYa(n) to achieve a physical layer module function. For example, the physical layer module PHYa(n) may detect whether a device is connected, and when a device is connected, it charges the connected device and sends out or receives signals to exchange data with the connected device. Moreover, the interface port Pa(n) also includes an AND gate 14 coupled to the status register 12 and the physical layer module PHYa(n). When the device is connected to the interface port Pa(n), if the device requires to be charged, the physical layer module PHYa(n) sends out a request Qa(n), and the AND gate 14 does an AND operation of the request Qa(n) and the bit Ra(n) to form a response signal Aa(n). The response signal Aa(n) informs the physical layer module PHYa(n) whether the interface port Pa(n) can be used as a charging port.

In the controller 10, the contents of the bits Ra(1) to Ra(N) are constant. For example, only the bit Ra(N) in FIG. 1 is logic 1, and other bits Ra(1) to Ra(N−1) are logic 0. Consequently, only the interface port Pa(N) can be used as the charging port. In other interface ports Pa(n) (the value of n does not equal to that of N), since the bit Ra(n) is logic 0, the corresponding response signal Aa(n) is negative, and the interface port Pa(n) cannot be used as the charging port. That is, when the user charges the device, he or she should connect the device to the interface port Pa(N). If the device is connected to other interface ports, it cannot be charged.

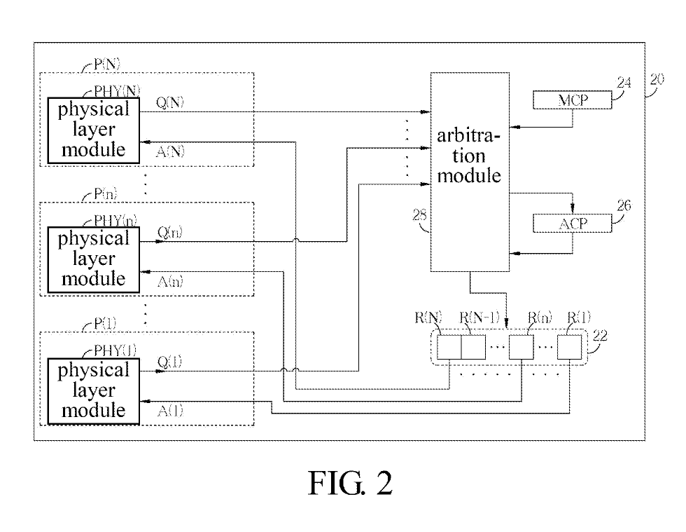

FIG. 2 is a schematic diagram showing a charging port configuration of a controller 20 in an embodiment. The controller 20 controls interface ports P(1) to P(N) and includes a first register 24, a second register 26, a status register 22 and an arbitration module 28. The first register 24 records a maximum permission value MCP (which may be a preset constant value), and the second register 26 records a permitted value ACP. The status register 22 includes bits R(1) to R(N) as status bits corresponding to the interface ports P(1) to P(N). The bit R(n) corresponds to the interface port P(n), and its content indicates whether the interface port P(n) can be used as the charging port.

Each of the interface ports P(1) to P(N) may conform to the USB specification, and the interface port P(n) is taken as an example herein. The interface port P(n) may be connected to a device (not shown) and includes a physical layer module PHY(n) to achieve the physical layer function. For example, the physical layer module PHY(n) may detect whether a device is connected, and when a device is connected, it charges the connected device and sends out or receives signals to exchange data with the connected device. When the device is connected to the interface port P(n) and generates a charging request, the physical layer module PHY(n) sends out a request Q(n) and receives a corresponding response signal A(n). The response signal A(n) informs the physical layer module PHY(n) whether the interface port P(n) can be used as the charging port. In FIG. 2, the interface port P(n) is coupled to the status register 22 and takes the content of the bit R(n) as the response signal A(n).

The arbitration module 28 is coupled to the physical layer modules PHY(1) to PHY(N) and receives the requests Q(1) to Q(N). The arbitration module 28 is also coupled to the first register 24, the second register 26 and the status register 22. The arbitration module 28 can read the maximum permission value MCP from the first register 24, read and change the permitted value ACP recorded in the second register 26, and it also can read or change the bits R(1) to R(N) recorded in the status register 22, respectively. The maximum permission value MCP represents that how many interface ports of the interface ports can be used as the charging ports, which is determined by the total current of the controller 20 and the rated charging current of one charging port. The permitted value ACP represents how many interface ports of the interface ports are used as the charging ports.

The arbitration module 28 dynamically configures the charging ports for the controller 20. When a device is connected to an interface port P(n) (the value of n may equal to 1 to the value of N), if the device generates a charging request, the physical layer module PHY(n) sends out a request Q(n). According to the charging request of the device, the arbitration module 28 compares the maximum permission value MCP and the permitted value ACP to determine whether the interface port P(n) can be used as the charging port. If the maximum permission value MCP is larger than the permitted value ACP, it means that the controller 20 also can provide the charging port. Consequently, the arbitration module 28 sets the corresponding bit R(n) of the interface port P(n) at logic 1 to permit the interface port P(n) to be used as the charging port. The arbitration module 28 also changes the permitted value ACP correspondingly. For example, the permitted value ACP increases by one to represent the number of the interface ports used as the charging port increases by one. When the physical layer module PHY(n) gets permission from the response signal A(n), it informs the connected device, and the connected device gets charging power (or current) from the interface port P(n).

In contrast, when the physical layer module PHY(n) sends out the request Q(n) according to the charging request of the device, if the maximum permission value MCP equals to the permitted value ACP, it means that the controller 20 cannot provide more charging ports. Consequently, the arbitration module 28 keeps the bit R(n) at logic 0 and forbids the interface port P(n) to be used as the charging port. The physical layer module PHY(n) does not get permission from the response signal A(n) and informs the connected device that the connected device cannot get excessive current.

As stated above, the charging ports can be dynamically configured. If the condition is met (MCP>ACP), each of the interface ports P(n) can be used as the charging port. No matter which interface port the user connects the device to, the device can be charged.

When the device is detached from an interface port P(n) (the value n may equal to 1 to the value of N), the physical layer module PHY(n) informs the arbitration module 28, and the arbitration module 28 checks whether the bit R(n) of the interface port P(n) is logic 1. If yes, it means that the interface port P(n) is just used as the charging port. Then, the arbitration module 28 restores the permitted value ACP to the previous value. For example, the permitted value ACP decreases by one to represent that one of the charging ports is released. Moreover, the arbitration module 28 resets the bit R(n) of the interface port P(n) at logic 0.

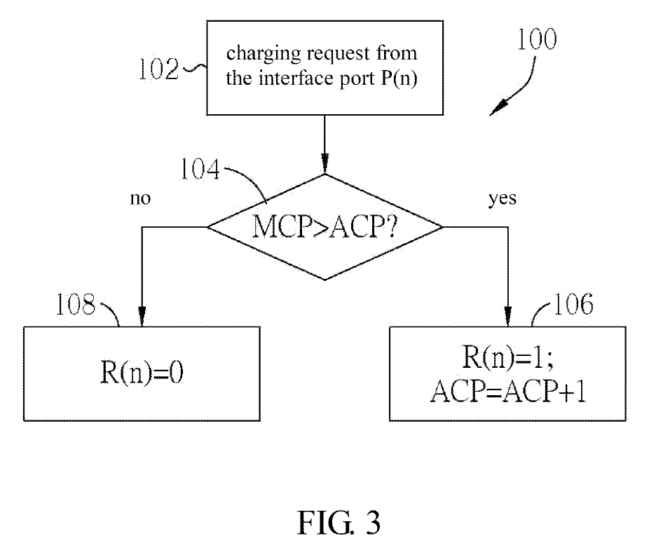

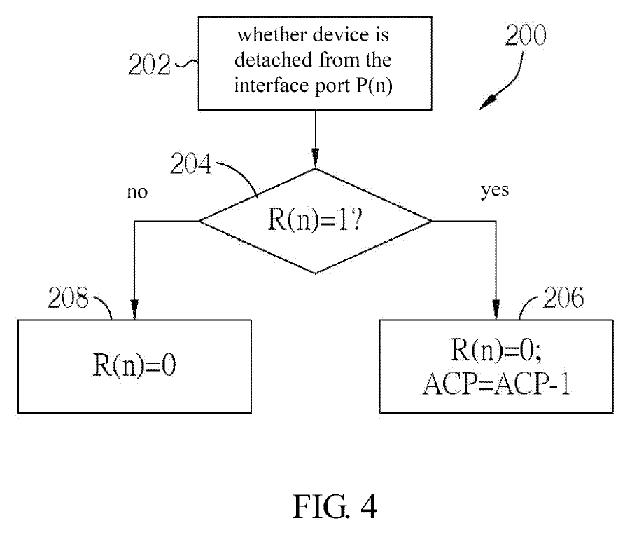

FIG. 3 and FIG. 4 are flow charts 100 and 200 showing operation steps of the controller 20 in FIG. 2.

The flow chart 100 mainly includes the following steps. At Step 102, a device is connected to one interface port P(n) and generates a charging request; At step 104, the maximum permission value MCP and the permitted value ACP are compared, and if the maximum permission value MCP is larger than the permitted value ACP, Step 106 is executed, otherwise, Step 108 is executed; At step 106, the corresponding bit R(n) of the interface port P(n) is set at logic 1 to permit the interface port P(n) to be used as the charging port, and the permitted value ACP increases by one; At step 108, the bit R(n) is retained at logic 0 and the interface port P(n) is not permitted to be used as the charging port.

The flow chart 200 mainly includes the following steps. At step 202, a device is detached from one interface port P(n); At step 204, whether the corresponding bit R(n) of the interface port P(n) is at logic 1 is detected, and if yes, Step 206 is executed, otherwise, Step 208 is executed; At step 206, the bit R(n) is reset at logic 0 and the permitted value ACP decreases by one to restore to the previous permitted value; At step 208, the bit R(n) is kept at logic 0.

In the embodiment, it is determined that whether other interface ports are available to be used as the charging port according to the maximum permission value MCP and the permitted value ACP of registers 24 and 26. Similarly, the first register 24 and the second register 26 may record a maximum permission value MCP and a permission balance value (MCP-ACP), respectively, to control the charging port configuration. The permission balance value equals to the difference value between the maximum permission value MCP and the permitted value ACP. When the permission balance value is larger than 0, the interface port which receives a charging request can be configured as the charging port, and the permission balance value decreases by one. When a charging port is not connected to the device, the permission balance value increases by one. Furthermore, the maximum permission value MCP may also be a maximum permission total current (total voltage or total power), and the permitted value ACP is the total permitted current (total permitted voltage or total permitted power) of each of the interface ports used as the charging ports. In the embodiment, when the permitted value ACP is reset in Step 106, the permitted value ACP may equals to the total value of the permitted value ACP and CPI(n), and the value of the CPI(n) represents the current (voltage or power) needed by the interface port P(n). Correspondingly, when the permitted value ACP is restored in Step 206, the permitted value ACP may equals to the difference value between the permitted value ACP and the value of CP1(n).

In sum, if the power supply of the electronic system permits (the maximum permission value MCP is larger than the permitted value ACP), the charging port can be dynamically and flexibly configured, and each of the interface ports can be used as the charging port to charge the connected device. The controller may be a hub controller or a host controller which conforms to the USB specification, so as to apply the charging port configuration technology to the electronic systems with USB interface ports under the battery charging specification, and the electronic system may be a hub, a motherboard or a computer system.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method for configuring charging ports, comprising:
recording a maximum permission value;
recording a permitted value; and
comparing the maximum permission value and the permitted value to determine whether an interface port is used as a charging port when a device is connected to the interface port.

2. The method according to claim 1, wherein the method further includes:
permitting the interface port to be used as the charging port if the maximum permission value is larger than the permitted value.

3. The method according to claim 1, wherein the method further includes:
forbidding the interface port to be used as the charging port if the maximum permission value equals to the permitted value.

4. The method according to claim 1, wherein the method further includes:
recording a status bit of the interface port;
permitting the interface port to be used as the charging port when the status bit is a first content, and forbidding the interface port to be used as the charging port when the status bit is a second content; and
setting the status bit at the first content when the interface port is used as the charging port.

5. The method according to claim 4, wherein the method includes:
checking whether the status bit is the first content when the device is detached from the interface port, and
setting the status bit at the second content if the status bit is the first content.

6. The method according to claim 4, wherein the method includes:
changing the permitted value when the interface port is used as the charging port.

7. The method according to claim 6, wherein the method includes:
checking whether the status bit is the first content when the device is detached from the interface port, and
restoring the permitted value if the status bit is the first content.

8. A controller for controlling an interface port, comprising:
a first register recording the maximum permission value;
a second register recording the permitted value;
an arbitration module connecting to the first register and second register and comparing the maximum permission value and the permitted value to determine whether the interface port is used as a charging port when a device is connected to the interface port.

9. The controller according to claim 8, wherein if the maximum permission value is larger than the permitted value, the arbitration module permits the interface port to be used as the charging port.

10. The controller according to claim 8, wherein if the maximum permission value equals to the permitted value, the arbitration module forbids the interface port to be used as the charging port.

11. The controller according to claim 8, wherein the controller further includes:
a status register recording a status bit;
wherein if the arbitration module compares the maximum permission value and the permitted value and sets the status bit at a first content, the interface port is used as the charging port, and if the arbitration module compares the maximum permission value and the permitted value and sets the status bit at a second content, the interface port is not permitted to be used as the charging port.

12. The controller according to claim 11, wherein when the device is detached from the interface port and the arbitration module detects that the status bit is the first content, the arbitration module sets the status bit at the second content.

13. The controller according to claim 11, wherein when the arbitration module permits the interface port to be used as the charging port, the arbitration module changes the permitted value.

14. The controller according to claim 13, wherein when the device is detached from the interface port and the arbitration module detects that the status bit is the first content, the arbitration module restores the permitted value.
